(19) United States
(12) Patent Application Publication
(10) Pub. No.: US 2023/0163896 A1
(43) Pub. Date: May 25, 2023

(54) METHOD OF PERFORMING FEEDBACK TRANSMISSION FOR MULTICAST OR BROADCAST SERVICE AND RELATED DEVICE

(71) Applicant: FG Innovation Company Limited, Tuen Mun (HK)

(72) Inventors: CHIA-HUNG LIN, Taipei (TW); CHIA-HAO YU, Taipei (TW); HUNG-CHEN CHEN, Taipei (TW); HENG-LI CHIN, Taipei (TW); YUNG-LAN TSENG, Taipei (TW); MEI-JU SHIH, Taipei (TW)

(21) Appl. No.: 18/010,043

(22) PCT Filed: Jun. 15, 2021
(86) PCT No.: PCT/CN2021/100178

§ 371 Date: Dec. 13, 2022

Related U.S. Application Data
(60) Provisional application No. 63/041,809, filed on Jun. 19, 2020.

(51) Int. Cl. H04L 1/1829; H04L 5/00; H04W 72/30

(52) U.S. Cl. CPC H04L 1/1858; H04L 5/0055; H04W 72/30

(57) ABSTRACT

A method of performing a feedback transmission for a multicast or broadcast service (MBS) for a user equipment (UE) is provided. The method includes receiving, from a base station (BS), a RRC message enabling the UE to provide HARQ ACK information for a PDSCH reception corresponding to the MBS; receiving, from the BS, a first DCI format that schedules a first PDSCH for receiving MBS data, the first DCI format being a DCI format with CRC scrambled by a G-RNTI; determining a PUCCH resource according to the first DCI format; transmitting, to the BS, first HARQ ACK information corresponding to the first PDSCH on the PUCCH resource; and receiving, from the BS, a second PDSCH providing a retransmission of the MBS data, the second PDSCH being scheduled by a second DCI format using the G-RNTI or a C-RNTI.

### CROSS-REFERENCE TO RELATED APPLICATION(S)

The present disclosure is a National Stage application of International Patent Application Serial No. PCT/CN2021/100178, filed on Jun. 15, 2021, claims the benefit of and priority to U.S. Provisional Patent Application Ser. No. 63/041,809, filed on Jun. 19, 2020. The contents of all of the above-mentioned applications are hereby incorporated fully by reference into the present disclosure.

### FIELD

The present disclosure is generally related to wireless communications and, more specifically, to a method of performing a feedback transmission for a multicast or broadcast service (MBS) and a related device.

### BACKGROUND

With the tremendous growth in the number of connected devices and the rapid increase in user/network traffic volume, various efforts have been made to improve different aspects of wireless communication for the next-generation wireless communication system, such as the fifth-generation (5G) New Radio (NR) system, by improving data rate, latency, reliability, and mobility.

The 5G NR system is designed to provide flexibility and configurability for optimizing the network services and types and accommodating various use cases such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communication for the next-generation wireless communication system.

### SUMMARY

The present disclosure provides a method of performing a feedback transmission for a multicast or broadcast service (MBS) and a related device.

According to an aspect of the present disclosure, a method of performing a feedback transmission for an MBS for a user equipment (UE) is provided. The method includes receiving, from a base station (BS), a radio resource control (RRC) message enabling the UE to provide Hybrid Automatic Repeat Request (HARQ) Acknowledgment (ACK) information for a physical downlink shared channel (PDSCH) reception corresponding to the MBS; receiving, from the BS, a first downlink control information (DCI) format that schedules a first PDSCH for receiving MBS data, the first DCI format being a DCI format with Cyclic Redundancy Check (CRC) scrambled by a Group-Radio Network Temporary Identifier (G-RNTI); determining a physical uplink control channel (PUCCH) resource according to the first DCI format; transmitting, to the BS, first HARQ ACK information corresponding to the first PDSCH on the PUCCH resource; and receiving, from the BS, a second PDSCH providing a retransmission of the MBS data, the second PDSCH being scheduled by a second DCI format using the G-RNTI or a Cell-Radio Network Temporary Identifier (C-RNTI).

According to another aspect of the present disclosure, a UE for performing a feedback transmission for an MBS is provided. The UE includes at least one processor; and at least one memory coupled to the at least one processor, the at least one memory storing computer-executable instructions that, when executed by the at least one processor, cause the UE to perform the method.

According to another aspect of the present disclosure, a base station (BS) for performing a feedback transmission for an MBS is provided. The BS includes at least one processor; and at least one memory coupled to the at least one processor, the at least one memory storing computer-executable instructions that, when executed by the at least one processor, cause the BS to: transmit, to a user equipment (UE), a radio resource control (RRC) message enabling the UE to provide Hybrid Automatic Repeat Request (HARQ) Acknowledgment (ACK) information for a physical downlink shared channel (PDSCH) reception corresponding to the MBS; transmit, to the UE, a first downlink control information (DCI) format that schedules a first PDSCH for transmitting MBS data, the first DCI format being a DCI format with Cyclic Redundancy Check (CRC) scrambled by a Group-Radio Network Temporary Identifier (G-RNTI); receive, from the UE, first HARQ ACK information corresponding to the first PDSCH on a physical uplink control channel (PUCCH) resource; and transmit, to the UE, a second PDSCH providing a retransmission of the MBS data, the second PDSCH being scheduled by a second DCI format using the G-RNTI or a Cell-Radio Network Temporary Identifier (C-RNTI).

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating multiple DL physical resources for the same multicast/broadcast service (MBS) transmission, according to an implementation of the present disclosure.

FIG. 2 is a diagram illustrating every MBS transmission configured with the same setting of UL physical resource configuration, according to an implementation of the present disclosure.

FIG. 3 is a diagram illustrating MBS repetitions with multiple UL physical resources, according to an implementation of the present disclosure.

FIG. 4 is a diagram illustrating MBS repetitions with one UL physical resource, according to an implementation of the present disclosure.

FIG. 5 is a diagram illustrating one MBS transmission with multiple UL physical resources, according to an implementation of the present disclosure.

FIG. 6 is a flowchart illustrating a method of performing a feedback transmission for an MBS, according to an implementation of the present disclosure.

FIG. 7 is a block diagram illustrating a node for wireless communication, according to an implementation of the present disclosure.

### DESCRIPTION

The following disclosure contains specific information pertaining to exemplary implementations in the present disclosure. The drawings and their accompanying detailed disclosure are directed to exemplary implementations. However, the present disclosure is not limited to these exemplary implementations. Other variations and implementations of the present disclosure will occur to those skilled in the art. Unless noted otherwise, like or corresponding elements in the drawings may be indicated by like or corresponding reference numerals. Moreover, the drawings and illustrations are generally not to scale and are not intended to correspond to actual relative dimensions.

For consistency and ease of understanding, like features are identified (although, in some examples, not shown) by reference designators in the exemplary drawings. However, the features in different implementations may be different in other respects, and therefore shall not be narrowly confined to what is shown in the drawings.

The phrases “in one implementation,” and “in some implementations,” may each refer to one or more of the same or different implementations. The term “coupled” is defined as connected, whether directly or indirectly via intervening components, and is not necessarily limited to physical connections. The term “comprising” may mean “including, but not necessarily limited to” and specifically indicate open-ended inclusion or membership in the disclosed combination, group, series, and equivalents.

The term “and/or” herein is only an association relationship for describing associated objects and represents that three relationships may exist; for example, A and/or B may represent that: A exists alone, A and B exist at the same time, and B exists alone. “A and/or B and/or C” may represent that at least one of A, B, and C exists, A and B exist at the same time, A and C exist at the same time, B and C exist at the same time, and A, B and C exist at the same time. Besides, the character “/” used herein generally represents that the former and latter associated objects are in an “or” relationship.

Additionally, any two or more of the following paragraphs, (sub)-bullets, points, actions, behaviors, terms, alternatives, examples, or claims in the present disclosure may be combined logically, reasonably, and properly to form a specific method. Any sentence, paragraph, (sub)-bullet, point, action, behavior, term, or claim in the present disclosure may be implemented independently and separately to form a specific method. Dependency, e.g., “based on”, “more specifically”, “preferably”, “in one embodiment”, “in one implementation”, “in one alternative”, in the present disclosure may refer to just one possible example that would not restrict the specific method.

For a non-limiting explanation, specific details, such as functional entities, techniques, protocols, standards, and the like, are set forth for providing an understanding of the disclosed technology. In other examples, detailed disclosure of well-known methods, technologies, systems, and architectures are omitted so as not to obscure the present disclosure with unnecessary details.

Persons skilled in the art will recognize that any disclosed network function(s) or algorithm(s) may be implemented by hardware, software, or a combination of software and hardware. Disclosed functions may correspond to modules that may be software, hardware, firmware, or any combination thereof. The software implementation may include computer-executable instructions stored on a computer-readable medium, such as memory or other types of storage devices. For example, one or more microprocessors or general-purpose computers with communication processing capability may be programmed with corresponding executable instructions and carry out the disclosed network function(s) or algorithm(s). The microprocessors or general-purpose computers may be formed of Application-Specific Integrated Circuits (ASICs), programmable logic arrays, and/or one or more Digital Signal Processors (DSPs). Although some of the disclosed implementations are directed to software installed and executing on computer hardware, nevertheless, alternative implementations as firmware, as hardware, or as a combination of hardware and software are well within the scope of the present disclosure.

The computer-readable medium may include, but may not be limited to, Random Access Memory (RAM), Read-Only Memory (ROM), Erasable Programmable Read-Only Memory (EPROM), Electrically Erasable Programmable Read-Only Memory (EEPROM), flash memory, Compact Disc (CD) Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a New Radio (NR) system) may typically include at least one base station (BS), at least one UE, and one or more optional network elements that provide connection with a network. The UE may communicate with the network (e.g., a Core Network (CN), an Evolved Packet Core (EPC) network, an Evolved Universal Terrestrial Radio Access Network (E-UTRAN), a Next-Generation Core (NGC), a 5G Core (5GC), or an internet) via a Radio Access Network (RAN) established by one or more BSs.

A UE according to the present disclosure may include, but is not limited to, a mobile station, a mobile terminal or device, or a user communication radio terminal. For example, a UE may be a portable radio equipment that includes, but is not limited to, a mobile phone, a tablet, a wearable device, a sensor, or a Personal Digital Assistant (PDA) with wireless communication capability. The UE may be configured to receive and transmit signals over an air interface to one or more cells in a RAN.

ABS may include, but is not limited to, a node B (NB) as in the Universal Mobile Telecommunication System (UMTS), an evolved node B (eNB) as in the LTE-A, a Radio Network Controller (RNC) as in the UMTS, a Base Station Controller (BSC) as in the Global System for Mobile communications (GSM)/GSM Enhanced Data rates for GSM Evolution (EDGE) RAN (GERAN), a next-generation eNB (ng-eNB) as in an Evolved Universal Terrestrial Radio Access (E-UTRA) BS in connection with the 5GC, a next-generation Node B (gNB) as in the 5G-RAN (or in the 5G Access Network (5G-AN)), and any other apparatus capable of controlling radio communication and managing radio resources within a cell. The BS may connect to serve the one or more UEs via a radio interface to the network.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GRPS), UMTS (often referred to as 3G) according to basic Wideband-Code Division Multiple Access (W-CDMA), High-Speed Packet Access (HSPA), LTE, LTE-A, enhanced LTE (eLTE), NR (often referred to as 5G), and/or LTE-A Pro. However, the scope of the present disclosure is not limited to these protocols.

The BS may be operable to provide radio coverage to a specific geographical area using a plurality of cells forming the RAN. The BS may support the operations of the cells. Each cell may be operable to provide services to at least one UE within its radio coverage. More specifically, each cell (often referred to as a serving cell) may provide services to serve one or more UEs within its radio coverage (e.g., each cell schedules the downlink (DL) and optionally UL resources to at least one UE within its radio coverage for DL and optionally UL packet transmissions). The BS may communicate with one or more UEs in the radio communication system via the plurality of cells.

A cell may allocate Sidelink (SL) resources for supporting Proximity Service (ProSe), LTE SL services, and LTE/NR Vehicle-to-Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As disclosed previously, the frame structure for NR is to support flexible configurations for accommodating various next-generation (e.g., 5G) communication requirements, such as eMBB, mMTC, and URLLC, while fulfilling high reliability, high data rate, and low latency requirements. The orthogonal frequency-division multiplexing (OFDM) technology, as agreed in the 3rd Generation Partnership Project (3GPP), may serve as a baseline for an NR waveform. The scalable OFDM numerology, such as the adaptive sub-carrier spacing, the channel bandwidth, and the cyclic prefix (CP), may also be used. Additionally, two coding schemes are applied for NR: (1) low-density parity-check (LDPC) code and (2) polar code. The coding scheme adaption may be configured based on the channel conditions and/or the service applications.

Moreover, in a transmission time interval of a single NR frame, at least DL transmission data, a guard period, and UL transmission data should be included. The respective portions of the DL transmission data, the guard period, and the UL transmission data should also be configurable, for example, based on the network dynamics of NR. An SL resource may also be provided via an NR frame to support ProSe services or V2X services.

In the 3GPP Rel-15 and Rel-16 NR, no broadcast/multicast services support is specified. Since multicast/broadcast service (MBS) can provide benefit in terms of system efficiency and user experience, MBS is a new work item (WI) in the 3GPP Rel-17 NR. This WI aims to provide the support in NR for several use cases (e.g., public safety and mission critical, V2X applications, transparent Internet Protocol version 4/Internet Protocol version 6 (IPv4/IPv6) multicast delivery, Internet Protocol Television (IPTV), software delivery over wireless, group communications, and Internet of Things (IoT) applications).

Multimedia broadcast/multicast service (MBMS) is an important feature for LTE. In MBMS, the spectral efficiency requirement is given in terms of carriers dedicated to broadcast transmission. However, LTE MBMS does not support dynamically adjusting resource allocation according to MBMS usage status (e.g., channel condition). In addition, the resource allocated specifically for MBMS is not released for other data transmission even though if no UEs need the corresponding MBMS, which causes resource wasting. Under this condition, the 3GPP Rel-13 LTE discusses a new feature (e.g., Single-Cell Point-to-Multipoint (SC-PTM)) to provide more flexible multicast/broadcast data transmission. SC-PTM applies MBMS system architecture, which enhances not only radio efficiency but also latency for the conventional MBMS. Unlike MBMS that uses the dedicated resources for broadcast/multicast services, SC-PTM transfers broadcast/multicast services via a Physical Downlink Shared Channel (PDSCH) scheduled by using a Group-Radio Network Temporary Identifier (G-RNTI). Therefore, the radio resources for broadcast/multicast services may be dynamically assigned in time/frequency via Physical Downlink Control Channel (PDCCH) in SC-PTM.

As previously mentioned, the LTE system applies MBMS and SC-PTM to support broadcast/multicast services. However, in NR, there is no MBS support specified in the first two NR releases (e.g., the 3GPP Rel-15 and Rel-16). In order to support broadcast/multicast services in NR, MBS has been introduced in the 3GPP Rel-17. The main objectives of the 3GPP Rel-17 for MBS are summarized as follows:

1. Specify a group scheduling mechanism to allow UEs to receive Broadcast/Multicast service;

2. Specify support for dynamic change of Broadcast/Multicast service delivery between multicast (PTM) and unicast (PTP) with service continuity for a UE;

3. Specify support for basic mobility with service continuity;

4. Specify required changes to improve reliability of Broadcast/Multicast service (e.g., by feedback transmission). The level of reliability may be based on the requirements of the application/service that is provided; and

5. Study the support for dynamic control of the Broadcast/Multicast transmission area within one gNB Distributed Unit (gNB-DU) and specify what is needed to enable it.

Among these objectives, how to enhance reliability of broadcast/multicast services may be a critical issue for NR because it is closely related to user experience. Several candidate techniques, such as acknowledgment/negative-acknowledgment (ACK/NACK) reporting, data repetition, and data retransmission, may be applied to enhance the reliability of broadcast/multicast services. From an efficiency point of view, feedback mechanisms are crucial when reliability enhancement is considered. Therefore, how to support feedback mechanisms (e.g., ACK/NACK reporting) for a group of UEs receiving the same broadcast/multicast services is the focused problem in this disclosure.

Generally, in the 3GPP Rel-15 and Rel-16, the Physical Uplink Shared Channel/Physical Uplink Control Channel (PUSCH/PUCCH) resources are configured to a UE to report ACK/NACK corresponding to the PDSCH reception or channel state information (CSI) via downlink control information (DCI) scrambled with Cell RNTI (C-RNTI). However, since MBS has not yet been discussed in NR and LTE MBMS does not support ACK/NACK reporting for MBMS data reception, the network may need to provide UL physical resources (e.g., time/frequency resources) for a UE to transmit feedback information (e.g., ACK/NACK, CSI) for reporting MBS reception status to the network to enhance NR MBS reliability. In addition, the UL physical resource may be used by the UE to send an indication to the gNB for requesting information of a certain MBS of interest.

It is noted that the signaling for configuring a UL physical resource may be classified as follows.

Class 1: Static/Semi-Static Signaling

A UL physical resource may be configured to an MBS-interested UE by a system information block (SIB) used for the MBS purpose. In one example, a SIBx may be used for indicating the UL physical resource to the UE to report MBS reception status of an MBS data/packet/Transport Block (TB). In another example, a radio resource control (RRC) message (e.g., MBS-dedicated or UE-dedicated RRC message) may be used for indicating the UL physical resource for the UE to report MBS reception status of an MBS data/packet/TB.

Class 2: Dynamic Signaling

A UL physical resource may be configured to an MBS-interested UE by DCI scrambled by an MBS-related RNTI (e.g., the RNTIs for identifying the UL physical resource for reporting MBS reception status), a common RNTI that associates with a common search space (CSS) set (e.g., System Information RNTI (SI-RNTI), a Paging RNTI (P-RNTI)), or a UE-specific RNTI that associates with a UE-specific search space (USS) set (e.g., C-RNTI). For example, an MBS-interested UE may obtain the UL physical resource for feedback transmission (e.g., MBS reception status feedback) via DCI monitored in a common search space, a UE-specific search space, or a dedicated search space set for MBS.

Based on the previously mentioned two classes of signaling, two types of UL physical resource are disclosed.

Type 1: MBS-Specific Physical Resources (e.g., Common UL Physical Resources)

For an MBS transmission (e.g., PDSCH/Physical Multicast Channel (PMCH) or TB associated with an MBS), one or more UL physical resources are configured to an MBS-interested UE to perform feedback transmission to transmit feedback information (e.g., NACK or CSI report). In one example, MBS-capable UEs interested in the same MBS may use common UL physical resources for feedback transmissions.

A UE may receive/obtain information/configuration/parameters associated with the UL physical resources (e.g., timing offset, frequency offset, starting time/frequency, ending time/frequency, duration of timer/frequency) via a dedicated RRC message, a SIBx, or DCI.

Type 2: UE-Specific Physical Resources (e.g., Dedicated UL Physical Resources)

An MBS-interested UE may have dedicated UL resource(s) for feedback transmission (e.g., MBS reception status feedback). An MBS-interested UE may obtain/receive a network (NW)-configured UL physical resource for feedback transmission via a dedicated RRC message, DCI, or a SIBx.

In one example, the network may configure multiple UL physical resources for transmitting feedback information for reporting MBS reception status via a SIBx. An MBS-capable UE may obtain the multiple UL physical resources configured by the network via a SIBx, and the MBS-capable UE may select one UL physical resource to report MBS reception status of an MBS data/packet/TB according to UE ID.

In one example, each UL physical resource for feedback transmission (e.g., MBS reception status feedback) may be assigned with an index by the network, and thus an MBS-capable UE may select the UL physical resource with index ‘K’ to report MBS recaption status of an MBS data/packet/TB. The index ‘K’ may be obtained by a formula (e.g., mod(UE ID, total number of configured UL physical resources). It is noted that different MBS-capable UEs may select the same UL physical resource to report MBS reception status if the total number of configured UL physical resource is smaller than the total number of MBS-capable UEs receiving the same MBS.

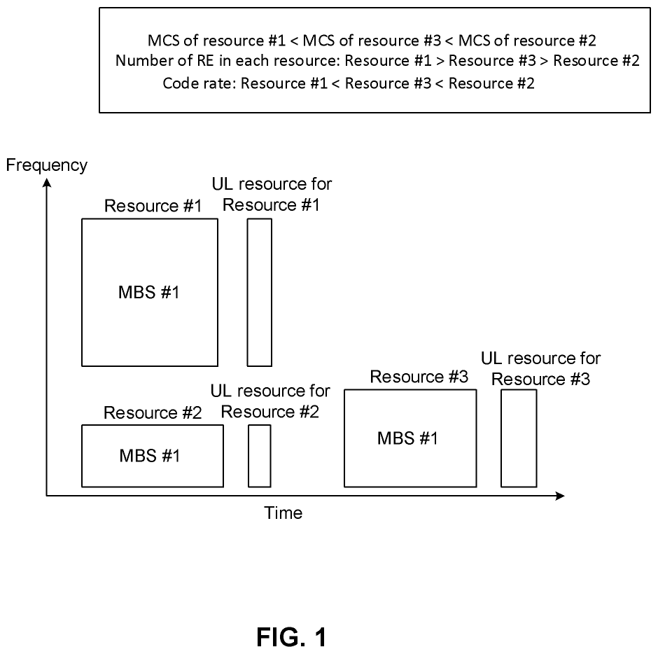

FIG. 1 is a diagram illustrating multiple DL physical resources for the same MBS transmission, according to an implementation of the present disclosure. As illustrated in FIG. 1, DL physical resources (e.g., Resource #1-Resource #3) are configured with 3 different sizes. The network may indicate multiple DL physical resources (e.g., time, frequency, bandwidth part (BWP), cell identity) to an MBS-capable UE to receive the same MBS data/packet/TB (e.g., MBS #1) with different configurations (e.g., Modulation and Coding Scheme (MCS), Redundancy Version (RV), Transmit Power Control (TPC)) via a dedicated RRC message, a SIBx, or DCI. In one example, the UE may be configured with one DL physical resource to receive MBS data/packet/TB (e.g., MBS #1). In one example, the UE may be configured with multiple DL physical resources to receive MBS data/packet/TB. In one example, the network may configure multiple DL physical resources to an MBS-capable UE for MBS data/packet/TB, and a threshold value may also be transmitted to the MBS-capable UE to select which DL physical resource that the MBS-capable UE could use to receive MBS data/packet/TB. In one example, one UL physical resource may be used by the UE to perform feedback transmission corresponding to the received MBS data/packet/TB. In other words, the UE transmits feedback information (e.g., ACK/NACK) for reporting MBS reception status to the network on the UL physical resource, so that the network can determine whether to perform an MBS retransmission according to the feedback information, to increase MBS reliability. The MBS reception status may include one or multiple MBS (services/sessions) with the same (set of) configuration. The (set of) configuration may include (but may not be limited to) MCS, RV, TPC.

In this disclosure, methods for reliable MBS transmission are provided.

UL Feedback Resource Configuration

UL physical resources for a feedback transmission (e.g., MBS reception status feedback) may be configured to an MBS-interested UE by DCI scrambled with an MBS-related RNTI (e.g., the RNTI used for identifying UL physical resource used for reporting MBS reception status), a common RNTI that associates with a common search space set (e.g., SI-RNTI, P-RNTI), or a UE-specific RNTI that associates with a UE-specific search space set (e.g., C-RNTI). For example, the MBS-interested UE may obtain UL physical resources for MBS reception status feedback via the DCI monitored in a common search space, a UE-specific search space, or a dedicated search space set for MBS. Specifically, a set of PDCCH candidates for an MBS-capable UE to obtain/receive configurations of UL physical resource (namely UL feedback resource configuration) may be PDCCH CSS sets, PDCCH USS sets, or search space sets configured specifically for monitoring MBS related PDCCH. An MBS-capable UE may monitor PDCCH candidates in one or more of the following search space set(s) to obtain the UL physical resource for feedback transmission.

1. A USS set configured by SearchSpace in PDCCH-Config with searchSpaceType=ue-Specific for DCI with Cyclic Redundancy Check (CRC) scrambled by an MBS-related RNTI (e.g., G-RNTI, MBMS RNTI (M-RNTI));

2. A Type3-PDCCH CSS set configured by SearchSpace in PDCCH-Config with searchSpaceType=common for DCI with CRC scrambled by an MBS-related RNTI (e.g., G-RNTI, M-RNTI); and

3. A PDCCH SS set used for an MBS-related PDCCH monitoring configured by MBS-SearchSpace (e.g., MBS-dedicated search space) in PDCCH-ConfigCommon for DCI with CRC scrambled by a C-RNTI, or an MBS-related RNTI (e.g., G-RNTI, M-RNTI).

The UL physical resources may be configured to the MBS-capable UE to transmit feedback information (e.g., ACK/NACK, CSI report) corresponding to the received MBS data (e.g., PDSCH/PMCH, packet, TB associated with an MBS).

The network may indicate a dedicated UL physical resource for reporting feedback information (e.g., ACK/NACK, CSI report) corresponding to the received MBS data. The dedicated UL physical resource may be PUCCH, PUSCH, or NR MBS-dedicated physical feedback channel (e.g., Physical MBS Feedback Channel (PMFCH)).

A dedicated UL physical resource (e.g., PUCCH, PUSCH or PMFCH) may be indicated to an MBS-capable UE to report MBS reception status of the received MBS data (e.g., PDSCH/PMCH used to carry MBS related packet/TB). The network may schedule UL physical resource(s) (e.g., PUCCH, PUSCH, or PMFCH) corresponding to the MBS transmission(s) (e.g., PDSCH/PMCH carrying an MBS-related packet/TB), and all MBS-capable UEs receiving the MBS transmission(s) may transmit feedback information (e.g., ACK/NACK) via the corresponding UL physical resource(s). In one example, only NACK information is fed back to inform that the UE fails to decode the received MBS data, to the gNB.

In this case, PUCCH format 0 and/or format 1 resource(s) may be used for the MBS reception status feedback.

A dedicated UL physical resource (e.g., PUCCH, PUSCH or PMFCH) may be indicated to an MBS-capable UE for reporting MBS reception status of the received MBS data (e.g., PDSCH/PMCH used to carry an MBS-related packet/TB). The network may indicate UL physical resource(s) (e.g., PUCCH, PUSCH, or PMFCH) for MBS transmission(s) (e.g., PDSCH/PMCH carrying an MBS-related packet/TB), and all MBS-capable UEs receiving the MBS transmission(s) may transmit feedback information (e.g., either ACK or NACK) to inform the decoding status of the received MBS data, to the gNB.

In one example, if an MBS-capable UE transmits feedback information (e.g., ACK or NACK) to inform the decoding status of the received MBS data, to the gNB, different cyclic shift indexes may be assigned to individual MBS-capable UEs.

In this case, PUCCH format 0 and/or format 1 resource(s) may be used for the MBS reception status feedback.

A dedicated UL physical resource (e.g., PUCCH, PUSCH or PMFCH) may be indicated to an MBS-capable UE for reporting MBS reception status of the received MBS data (e.g., PDSCH/PMCH used to carry an MBS-related packet/TB). Each MBS-capable UE may be indicated one dedicated UL physical resource (e.g., PUCCH, PUSCH or PMFCH) for transmitting feedback information corresponding to the received MBS data (e.g., PDSCH/PMCH used to carry an MBS-related packet/TB). An MBS-capable UE may transmit feedback information that only includes NACK to inform that the UE fails to decode the received MBS data, to the gNB.

Information for indicating whether the MBS supports the feedback mechanism may be predefined/(pre-)configured or signaled via a SIBx or a dedicated RRC message.

A predefined table may be used to indicate which MBS supports the feedback transmission. Table 1 illustrates a predefined table used for indicating which MBS service supports the feedback transmission. As illustrated in Table 1, the MBS #1 and the MBS #2 are predefined to support the feedback transmission. The MBS ID in Table 1 may represent different MBS (services/sessions), different Temporary Mobile Group Identity (TMGIs), or different MBS session IDs. Alternatively, the MBS ID field of the predefined table may be replaced by either a (DL) BWP, a cell, a frequency range, or a geographical area to indicate whether feedback transmission (e.g., MBS reception status feedback) is required for the MBS received at the (DL) BWP, cell, frequency range, or geographical area.

TABLE 1

| | Support feedback transmission or |
|---|---|
| MBS ID | not ‘1’ is supported; otherwise, ‘0’ |
| 0 | 0 |
| 1 | 1 |
| 2 | 1 |
| 3 | 0 |

In one example, an indication from the network (via SIBx, dedicated RRC message, Media Access Control (MAC) Control Element (CE)) regarding whether feedback transmission is supported for the corresponding MBS may override the indication from the predefined table. Specifically, if the predefined table indicates that feedback transmission (e.g., MBS reception status feedback) is not supported for the MBS #1, the UE may still transmit the feedback information for the MBS #1.

Scheduling information of MBS carried in a SIBx or a dedicated RRC message may include an Information Element (IE) to indicate whether the MBS supports the feedback transmission or to provide a bitmap used to indicate which MBS supports feedback transmission.

In one example, an MBS-capable UE may send an MBS request to the network to request the scheduling information of the MBS. The MBS request includes information about MBS which the UE is interested in (e.g., the MBS #2). The scheduling information of MBS #2 carried in a SIBx or a dedicated RRC message may include a field/configuration/information to indicate whether the MBS #2 supports feedback transmission.

In one example, if there are 6 MBSs, the scheduling information of MBS carried in the SIBx or the dedicated RRC message may include a field to provide a bitmap (e.g., ‘001101’) to indicate that MBS #0, MBS #1, and MBS #4 does not support the feedback transmission. In this example, the value ‘0’ means “not support feedback transmission” and the value ‘1’ means “support feedback transmission”.

A MAC CE may be used to indicate whether feedback transmission (e.g., MBS reception status feedback) is required for one or multiple MBSs. The MAC CE may include a bitmap, where each bit may be mapped to one MBS. Moreover, two values may be used for each bit in the MAC CE, which indicates whether feedback transmission is required for the corresponding MBS. A first value may be used to indicate that feedback transmission is required for the corresponding MBS, and a second value may be used to indicate that feedback transmission is not required for the corresponding MBS.

The scheduling information of MBS carried in a SIBx or a dedicated RRC message may implicitly indicate whether the MBS supports feedback transmission.

In one example, if the fields/IE(s) of scheduling information of MBS used to indicate UL physical resources for feedback transmission (e.g., MBS reception status feedback) are absent in the SIBx or the dedicated RRC message, the MBS may not support feedback transmission. In contrast, if the fields/IE(s) of scheduling information of MBS used to indicate UL physical resources for feedback transmission are presented/configured in the SIBx or the dedicated RRC message, the MBS may support feedback transmission.

The UL physical resources for feedback transmission corresponding to the received MBS data (e.g., a TB carried in PDSCH or PMCH associated with a broadcast/multicast service) may be predefined/(pre-)configured.

A timing gap (e.g., subframe, time slot, OFDM symbol, millisecond) between a UL physical resource (e.g., PDSCH, PUCCH) and an MBS PDSCH or an MBS PMCH may be predefined/(pre-)configured as ‘Ni’ OFDM symbols. Different MBSs (services/sessions) may be predefined/(pre-)configured with different values of ‘Ni’. Different MBSs may be predefined/(pre-)configured with the same value of ‘Ni’.

A timing duration (e.g., subframe, time slot, mini-second, OFDM symbol) of a UL physical resource for feedback transmission may be predefined/(pre-configured) as ‘N2’ OFDM symbols. Different MBSs (services/sessions) may be predefined/(pre-)configured with different values of ‘N2’. Different MBSs may be predefined/(pre-)configured with the same value of ‘N2’.

A frequency gap (e.g., subcarrier, Physical Resource Block (PRB)) between a UL physical resource for feedback transmission and a DL physical resource for MBS transmission may be predefined/(pre-)configured as ‘N3’ subcarriers or PRBs. Different MBSs (services/sessions) may be predefined/(pre-)configured with different values of ‘N3’. Different MBSs may be predefined/(pre-)configured with the same value of ‘N3’.

An MBS-capable UE may apply a similar configuration used for receiving MBS data (e.g., PDSCH/PMCH used to deliver the MBS data) to transmit the feedback information corresponding to the received MBS data over a UL physical resource. The configuration may include (but may not be limited to) a starting frequency point and a BWP.

The frequency range (e.g., subcarrier, PRB) of a UL physical resource for feedback transmission may be predefined/(pre-)configured as ‘N4’ PRB. Different MBSs (services/sessions) may be predefined/(pre-)configured with different values of ‘N4’. Different MBSs (services/sessions) may be predefined/(pre-)configured with the same value of ‘N4’.

The frequency range (e.g., subcarrier, PRB) of a UL physical resource for feedback transmission may be predefined to be the same as the frequency range (e.g., subcarrier, PRB) of the MBS.

The UL physical resources for feedback transmission corresponding to the received MBS data (e.g., PDSCH/PMCH or TB associated with an MBS) may be carried in a SIBx or a dedicated RRC message.

The UL physical resources for transmitting feedback information (e.g., ACK/NACK, CSI report) corresponding to the received MBS data (e.g., PDSCH/PMCH or TB associated with an MBS) may not be the same. That is, each MBS transmission may map to a dedicated UL physical resource.

Shared UL physical resources may be used by MBS-capable UEs to transmit feedback information corresponding to the received MBS data (e.g., PDSCH/PMCH or TB associated with an MBS). In other words, individual MBS transmissions (e.g., PDSCHs/PMCHs or TBs associated with individual transmissions of an MBS) may share UL physical resources.

The configuration of MBS-specific physical resources may be related to the time/frequency resource location of the received MBS transmissions (e.g., PDSCHs/PMCHs or TBs associated with MBS (services/sessions)).

A SIBx or an RRC message may carry at least one of the following RRC parameters.

1. The RRC parameter(s) used to indicate the timing gap (e.g., subframe, time slot, mini-second, OFDM symbol) between the DL physical resource for MBS transmission (e.g., PDSCH/PMCH or TB associated with an MBS) and the corresponding UL physical resource for feedback transmission;

2. The RRC parameter(s) used to indicate the timing duration (e.g., subframe, time slot, mini-second, OFDM symbol) of a UL physical resource;

3. The RRC parameter(s) used to indicate the frequency gap (e.g., subcarrier, PRB,) between the DL physical resource for MBS transmission (e.g., PDSCH/PMCH or TB associated with an MBS) and the corresponding UL physical resource for feedback transmission; and

4. The RRC parameter(s) used to indicate the frequency range (e.g., subcarrier, PRB) of a UL physical resource.

MBS (services/sessions) supporting feedback transmission may have the same RRC parameter(s) for determining/identifying associated UL physical resource(s).

Some MBS-specific configurations (e.g., starting PRB, number of symbols, starting timing position) of PUCCH or PUSCH associated with PDSCH or PMCH used to transmit MBS data/packet/TB may be indicated by SIBx. Some UE-specific configurations (e.g., transmit power of PUCCH or PUSCH, cyclic shift) of PUCCH or PUSCH associated with PDSCH or PMCH used to transmit MBS data/packet/TB may be indicated by a dedicated RRC message. When an MBS-capable UE reports MBS reception status of the received MBS PDSCH/PMCH, the MBS-capable UE may use indication(s) obtained via a SIBx and a dedicated RRC message to transmit feedback information to the gNB.

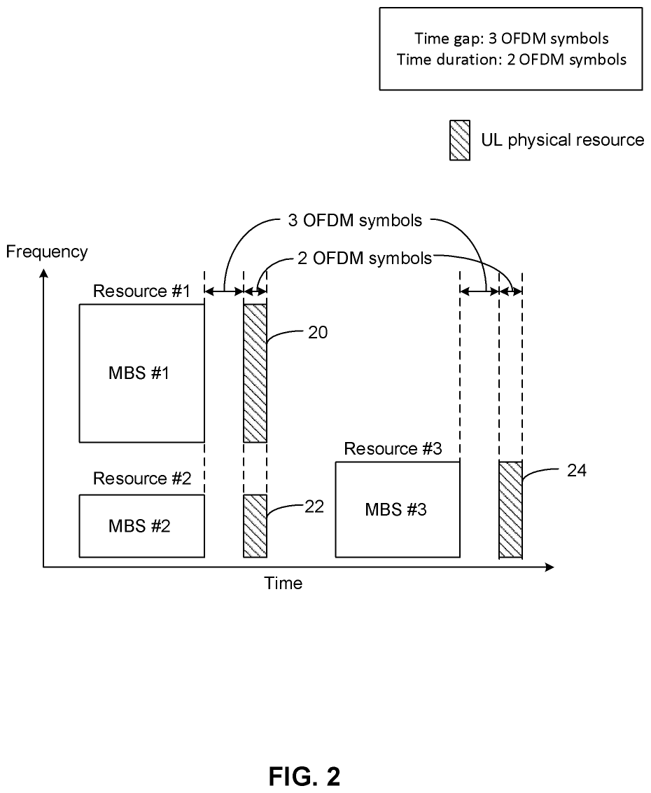

FIG. 2 is a diagram illustrating every MBS transmission with the same setting of UL physical resource configuration, according to an implementation of the present disclosure. As illustrated in FIG. 2, the frequency ranges of UL physical resources 20, 22 and 24 for feedback transmission corresponding to the received MBS data (e.g., MBS #1-MBS #3) may be predefined as the same as the frequency ranges of the received MBS transmissions (e.g., MBS #1-MBS #3). In this case, the timing gap and time duration may be 3 OFDM symbols and 2 OFDM symbols, respectively.

The UL physical resources for feedback transmission may be indicated in DCI.

A group of MBS-capable UEs that is interested in the same MBS service may monitor DCI scrambled with an MBS-related RNTI (e.g., G-RNTI, M-RNTI) in the same CORESET and/or search space set(s) (e.g., common search space, UE-specific search space, or MBS-dedicated search space) to obtain the UL physical resource to transmit feedback information corresponding to the received MBS data (e.g., PDSCH/PMCH or TB associated with an MBS).

In one example, an MBS-capable UE that is interested in an MBS may monitor the DCI format 1_0 scrambled with an MBS-related RNTI (e.g., M-RNTI, G-RNTI) to obtain the information/configuration of a UL physical resource. In one example, the DCI format 1_0 scrambled with an MBS-related RNTI may include fields used to indicate the UL physical resource for feedback transmission corresponding to the received MBS data (e.g., PDSCH/PMCH or TB associated with an MBS).

In one example, an MBS-capable UE that is interested in an MBS may monitor DCI (format 1_0) scrambled with an MBS-related RNTI (e.g., M-RNTI, G-RNTI) associated with the MBS to receive the (DL) scheduling information of the MBS. Moreover, an index may be indicated in this DCI, which maps to a specific set of UL physical resource parameters from a table that is configured by SIBx or dedicated RRC signaling, for supporting feedback transmission. The specific set of UL physical resource parameters may include at least one of:

Parameter 1: The timing gap between the DL physical resource for MBS transmission and the corresponding UL physical resource for feedback transmission;

Parameter 2: The timing duration of the corresponding UL physical resource;

Parameter 3: The frequency gap between the DL physical resource for MBS transmission and the corresponding UL physical resource for feedback transmission; and

Parameter 4: The frequency range of the corresponding UL physical resource.

An MBS-capable UE may monitor DCI scrambled with a UE-specific RNTI (e.g., C-RNTI) in an MBS-dedicated search space set(s) to obtain a UL physical resource to transmit feedback information corresponding to the received MBS data (e.g., PDSCH/PMCH or TB associated with an MBS). In one example, the DCI scrambled by the UE-specific RNTI (e.g., C-RNTI) monitored in the MBS-dedicated search space set(s) may include a field to indicate an MBS ID(s) to notify the association between the instructed UL physical resource and an MBS of interest, to the MBS-capable UE.

An MBS-capable UE may monitor the DCI format scrambled with C-RNTI in an MBS-dedicated search space configured via a dedicated RRC message to obtain the UE-specific configuration of a UL physical resource to transmit feedback information corresponding to the received MBS data (e.g., PDSCH/PMCH or TB associated with an MBS).

In one example, a table that maps each MBS-dedicated search space (configuration) to the corresponding set of parameters related to a UL physical resource for feedback transmission may be configured by the network via SIBx or RRC signaling. If a UE receives an MBS scheduling information on an MBS-dedicated search space, the UE may determine the set of parameters related to a UL physical resource for feedback transmission based on the table.

An MBS-capable UE may obtain the configuration of a UL physical resource for transmitting feedback information corresponding to the received MBS data (e.g., PDSCH/PMCH or TB associated with an MBS) and/or the MBS-dedicated search space (e.g., via dedicated RRC signaling). A UE-specific physical resource for transmitting feedback information corresponding to the received MBS data (e.g., PDSCH/PMCH or TB associated with an MBS) may be associated with a reference UL physical resource carried in DCI.

In one example, a reference UL physical resource may be the UL physical resource indicated in DCI scrambled with an MBS-related RNTI (e.g., via PUCCH resource indicator field and a field used to indicate the timing gap between the UL physical resource for feedback transmission and the DL physical resource for MBS transmission (e.g., PDSCH/PMCH or TB associated with an MBS)).

In one example, the following RRC parameters may be signaled (e.g., via a dedicated RRC message) for an MBS-capable UE to obtain the UL physical resource.

Δ_{T}: The timing gap between a UL physical resource and a reference UL physical resource. For example, the starting timing of UL physical resource for feedback transmission may be K₁+Δ_{T}, where K₁ may be obtained by the field used to indicate the timing gap between the UL physical resource for feedback transmission and the DL physical resource for MBS transmission (e.g., PDSCH/PMCH or TB associated with an MBS).

Δ_{F}: The frequency gap between a UL physical resource and a reference UL physical resource. For example, the starting frequency of the UL physical resource for feedback transmission may be RB_{BWP}^{offset}+Δ_{T}, where RB_{BWP}^{offset} may be obtained by the PUCCH resource indicator.

The previously mentioned RRC parameter(s) is used to indicate the timing duration (e.g., subframe, time slot, mini-second, OFDM symbol) of the UL physical resource.

UL Feedback Resource Configuration for Data Repetition

An MBS-capable UE may transmit ACK/NACK corresponding to the received MBS data/packet/TB to the gNB by the UL physical resource configured by the network.

The NR MBS may support data repetition, and/or individual repetition (of the data repetition(s)) may correspond to a UL physical resource for transmitting feedback information (e.g., ACK/NACK, CSI report).

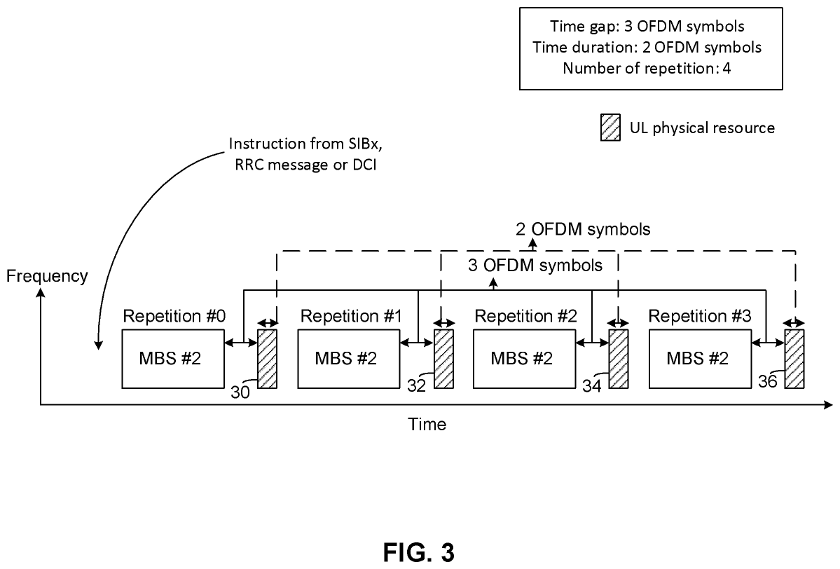

FIG. 3 is a diagram illustrating MBS repetitions with multiple UL physical resources, according to an implementation of the present disclosure. In this case, MBS data repetitions (e.g., the Repetition #0-Repetition #3) for an MBS (e.g., the MBS #2) may be accompanied by multiple UL physical resources 30-36 (e.g., PUCCH or PUSCH). As illustrated in FIG. 3, the scheduling information of the UL physical resource (e.g., the timing gap between the UL physical resources 30-36 and the DL physical resources for the MBS data/TB repetition (e.g., the Repetition #0-Repetition #3), the frequency gap between the UL physical resources 30-36 and the DL physical resources for the MBS data/TB repetition (e.g., the Repetition #0-Repetition #3), the timing duration of UL physical resource 30-36, and the number of repetitions of MBS data (e.g., 4 times)) may be configured to an MBS-capable UE via a SIBx, an RRC parameter, or DCI. Each MBS data repetition may be associated with a UL physical resource for reporting ACK/NACK with the timing gap being ‘X1’ OFDM symbols (e.g., X1=3) and the timing duration of the UL physical resource being ‘X2’ OFDM symbols (e.g., X2=2). In one example, the value of ‘X1’ and ‘X2’ may be a non-negative integer. In addition, ‘X1’ and ‘X2’ may be indicated via a SIBx, a dedicated RRC message, or DCI. In one example, the MBS-capable UE may select one UL physical resource among all UL physical resources for reporting ACK/NACK.

The NR MBS may support data repetition, and all repetitions may correspond to one single UL physical resource for feedback transmission (e.g., ACK/NACK).

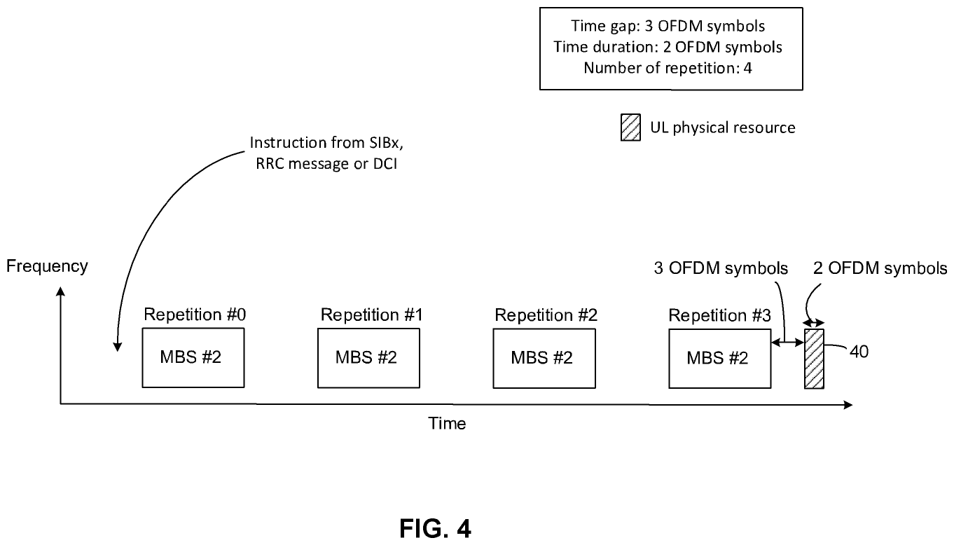

FIG. 4 is a diagram illustrating MBS repetitions with one UL physical resource, according to an implementation of the present disclosure. In this case, MBS data repetitions (e.g., the Repetition #0-Repetition #3) may be accompanied by one UL physical resource 40 (e.g., PUCCH or PUSCH). As illustrated in FIG. 4, the scheduling information of the UL physical resource (e.g., the timing gap between the UL physical resource 40 and the DL physical resource for the last MBS data/TB repetition (e.g., Repetition #3), the frequency gap between UL physical resource 40 and the DL physical resource for the last MBS data/TB repetition (e.g., Repetition #3), the timing duration of UL physical resource 40, the number of repetitions of MBS data/TB (e.g., 4 times)) may be configured to an MBS-capable UE via a SIBx, an RRC parameter, or DCI. Only the last repetition may be associated with one UL physical resource for transmitting ACK/NACK with the timing gap being ‘X1’ OFDM symbols (e.g., X1=3) and the timing duration of UL physical resource being ‘X2’ OFDM symbols (e.g., X2=2). In one example, the ‘X1’ and ‘X2’ may be a positive integer.

If a specific repetition of an MBS data/TB or an UL physical resource crosses a slot boundary, the specific repetition or the UL physical resource may be dropped.

If a repetition crosses a slot boundary, the MBS-capable UE may not expect to receive the repetition.

If the UL physical resource for feedback transmission crosses a slot boundary, the MBS-capable UE may not perform the feedback transmission on that UL physical resource.

If the UL physical resource for feedback transmission corresponding to the received MBS transmissions (e.g., PDSCH/PMCH or TB associated with an MBS) overlaps with other UL signals (e.g., PUCCH, PUSCH), the feedback transmission may be dropped.

If the UL physical resource for the feedback transmission overlaps with other UL signals (e.g., PUCCH, PUSCH), other UL signals may be dropped.

A priority may be configured/predetermined as follows:

Hybrid Automatic Repeat Request (HARQ)/ACK=Scheduling Request (SR)>MBS HARQ/ACK>CSI>PUSCH without Uplink Control Information (UCI)>SRS.

A priority level may (or may not) be indicated for the UL physical resource for feedback transmission corresponding to the received MBS data, and the priority level may be indicated via DCI/RRC signaling.

If the UL physical resource for the feedback transmission overlaps (in the time domain) with another UCI/PUSCH with the same priority level, the UL physical resource for the feedback transmission may be multiplexed with the UCI/PUSCH.

If the UL physical resource for the feedback transmission overlaps (in the time domain) with another UCI/PUSCH with a lower priority level, the UCI/PUSCH may be dropped, and the UL physical resource for the feedback transmission may be prioritized for transmission.

If the UL physical resource for the feedback transmission overlaps (in the time domain) with another UCI/PUSCH with the same priority level, the UCI/PUSCH may be dropped, and the UL resource may be prioritized for transmission.

If the UL physical resource overlaps (in the time domain) with another UCI/PUSCH with the same priority level, the UCI/PUSCH may be prioritized for transmission, and the feedback transmission corresponding to the received MBS data over the UL physical resource may be dropped.

If the UL physical resource for the feedback transmission overlaps (in the time domain) with another UCI/PUSCH with a higher priority level, the UCI/PUSCH may be prioritized for transmission, and the feedback transmission corresponding to the received MBS data over the UL physical resource may be dropped.

The network may configure multiple UL physical resources for the MBS-capable UEs interested in the same MBS to transmit feedback information corresponding to the received MBS data/packet/TB.

In one example, multiple UL physical resources may be mapped to one MBS transmission (e.g., PDSCH/PMCH or TB associated with an MBS) for the MBS-capable UEs interested in the MBS to transmit feedback information (e.g., ACK/NACK, CSI report). The MBS-capable UE may be indicated with which UL physical resource the UE may use to transmit feedback information via the following ways:

1. SIBx;

2. Dedicated RRC signaling;

3. DCI scrambled with a C-RNTI; or

4. DCI scrambled with an MBS-related RNTI (e.g., M-RNTI, G-RNTI,) in the UE-specific search space.

In one example, multiple UL physical resources may be mapped to one MBS transmission (e.g., PDSCH/PMCH or TB associated with an MBS) for the MBS-capable UEs interested in the MBS to transmit feedback information (e.g., ACK/NACK, CSI report). The MBS-capable UE may select a UL physical resource via a formula that may be associated with a UE ID and/or an MBS ID.

In one example, multiple UL physical resources may be mapped to one MBS transmission (e.g., PDSCH/PMCH or TB associated with an MBS) for the MBS-capable UEs interested in the MBS to transmit feedback information.

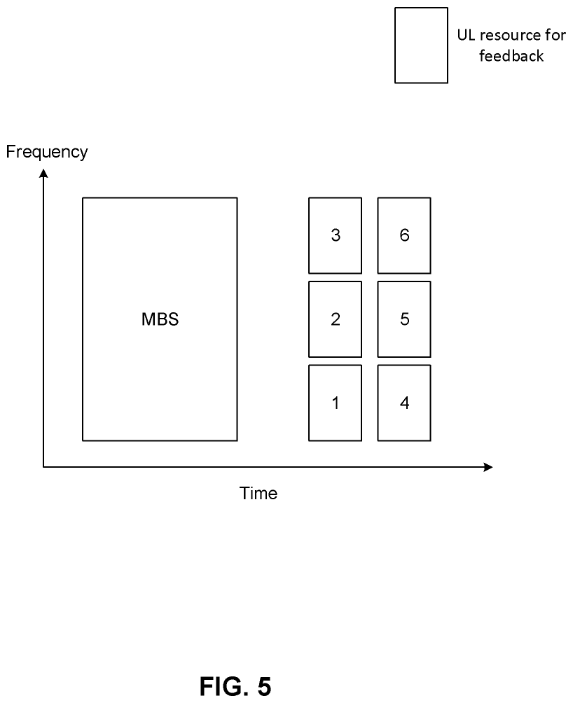

FIG. 5 is a diagram illustrating one MBS transmission with multiple UL physical resources, according to an implementation of the present disclosure. As illustrated in FIG. 5, the UL physical resources are configured with indexes 1-6. In one example, the indexing order of the UL physical resources may be in increasing order of frequency resource and/or in increasing order of time resource.

In one example, multiple UL physical resources may correspond to one MBS transmission (e.g., PDSCH/PMCH or TB associated with an MBS), where multiple MBS-capable UEs interested in the MBS transmission may share the same UL physical resources. If multiple MBS-capable UEs share the same UL physical resources for transmitting feedback information corresponding to the received MBS data (e.g., PDSCH/PMSCH or TB associated with an MBS), the feedback information may be limited to NACK. For example, the MBS-capable UEs use the same UL physical resources to transmit feedback information (e.g., feedback NACK-only) when the MBS-capable UEs fail to decode the received MBS data/TB. If multiple MBS-capable UEs use the same UL physical resources for transmitting feedback information corresponding to the received MBS data (e.g., PDSCH/PMSCH or TB associated with an MBS), different cyclic shifts may be assigned to individual MBS-capable UEs sharing the same UL physical resources for transmitting feedback information corresponding to the received MBS data (e.g., PDSCH/PMCH or TB associated with an MBS). If multiple MBS-capable UEs share the same UL resources for transmitting feedback information corresponding to the received MBS data (e.g., PDSCH/PMSCH or TB associated with an MBS), different power levels may be applied by individual MBS-capable UEs sharing the same UL resources for transmitting the feedback information. If multiple MBS-capable UEs share the same UL resources for transmitting feedback information corresponding to the received MBS data (e.g., PDSCH/PMSCH or TB associated with an MBS), different orthogonal sequences (e.g., gold sequence, pseudo random sequence) or partial orthogonal sequences (e.g., zadoff-cue sequence) may be assigned to individual MBS-capable UEs sharing the same UL resources for transmitting the feedback information.

In one example, assume that there are 12 MBS-capable UEs receiving the same MBS transmission and there are 6 UL physical resources mapped to that MBS transmission, and then each UL physical resource may be shared by 2 MBS-capable UEs.

UL Feedback Resource Configuration Based on Duplicated Transmission Configuration

As illustrated in FIG. 1, multiple scheduling information may be configured to transmit the same MBS data/packet/TB (e.g., MBS #1), where the DL physical resources (e.g., Resource #1-Resource #3) are configured with different MBS configurations (e.g., MCS, RV, TPC). The network may indicate one scheduling information to an MBS-capable UE to receive MBS data via a SIBx, a dedicated RRC message, or DCI.

The network may schedule multiple DL physical resources with different configuration(s) (e.g., MCS, RV, TPC) to transmit the same MBS data/packet/TB. On the other hand, an MBS-capable UE may transmit its channel condition (e.g., layer-1 DL reference signal received power (RSRP)/reference signal received quality (RSRQ)/received signal strength indicator (RSSI) measurement result, layer-3 DL RSRP measurement result) to the network, and thus the network may indicate one DL physical resource to that MBS-capable UE for receiving the MBS data according to the channel condition.

For example, the network may schedule 2 DL physical resources (e.g., Resource #1 is 2 PRBs and Resource #2 is 4 PRBs) to transmit the MBS #1. An MBS-capable UE that is interested in the MBS #1 may transmit its channel condition to the network. If its channel condition (e.g., RSRP, RSRQ) is good, the network may indicate Resource #1 to the UE for MBS data reception. Otherwise, the network may indicate Resource #2 to the UE for MBS data reception to increase MBS reliability.

As illustrated in FIG. 1, multiple scheduling information may be configured to transmit the same MBS data/packet/TB, where the DL physical resources (e.g., Resource #1-Resource #3) are configured with different MBS configurations (e.g., MCS, RV, TPC). The network may inform a threshold value and multiple scheduling information used to transmit the same MBS data/packet/TB to an MBS-capable UE via a SIBx, a dedicated RRC message, or DCI, so that the UE may select one DL physical resource to receive MBS data.

The network may configure multiple scheduling information used to transmit the same MBS data/packet/TB for an MBS-capable UE to receive as well as the threshold value (e.g., DL-RSRP, DL-RSSI), to the MBS-capable UE, so that the UE can select which DL physical resource the UE may use to receive the MBS data.

For example, the network may indicate 2 UL physical resources (e.g., Resource #1 is 2 PRBs and Resource #2 is 4 PRBs) to an MBS-capable UE to receive the MBS #1. The network may inform the threshold value (e.g., RSSI=−80 decibel-milliwatts (dBm)) to the MBS-capable UE. If the RSSI value of that MBS-capable UE is larger than −80 dBm, the UE may select the Resource #1 for MBS data reception. Otherwise, the UE may select the Resource #2 for MBS data reception.

As illustrated in FIG. 1, multiple scheduling information may be configured to transmit the same MBS data/packet/TB, where DL physical resources (e.g., Resource #1-Resource #3) are configured with different MBS configurations (e.g., MCS, RV, TPC). The priority order of the scheduling information for an MBS-capable UE to select for MBS data reception may be related to the MCS of the scheduling information. For example, multiple scheduling information may be configured to transmit the same MBS data/packet/TB, where DL physical resources (e.g., Resource #1-Resource #3) are configured with different MBS configurations (e.g., MCS, RV, TPC). The priority for an MBS-capable UE to select which DL physical resource for MBS data reception may depend on MCS index (in descending order) (e.g., the largest MCS index being determined as the highest priority for MBS data reception).

As illustrated in FIG. 1, the MCS used to transmit MBS data in the Resource #2 is the largest, and thus the Resource #2 has the highest priority for an MBS-capable UE for MBS data reception. That is, the MBS-capable UE may first select the Resource #2 for MBS data reception. If the MBS-capable UE fails to decode the MBS data in the Resource #2, the MBS-capable UE may select the Resource #3 with MCS smaller than MCS in the Resource #2 for MBS data reception. If the MBS-capable UE still fails to decode MBS data in the Resource #3, the MBS-capable UE may select the Resource #1 with the smallest MCS for MBS data reception. If the MBS-capable UE fails to decode MBS data in all DL physical resources provided by the network, the MBS-capable UE may request unicast transmission for MBS data reception.

As illustrated in FIG. 1, multiple scheduling information may be configured to transmit the same MBS data/packet/TB, where DL physical resources (e.g., Resource #1-Resource #3) are configured with different MBS configurations (e.g., MCS, RV, TPC). The network may indicate these DL physical resources to the MBS-capable UE. If the MBS-capable UE selects the resource that carries the lowest MCS MBS to receive MBS data and the MBS-capable UE fails to decode MBS, the MBS-capable UE may send the NACK to the gNB or send a unicast transmission request indicator carried by an RRC or preamble to the gNB for requesting the MBS data retransmission. The MBS-capable UE may monitor DCI to obtain the scheduling information of unicast transmission for MBS data reception.

The network may indicate 2 DL physical resources (e.g., Resource #1 is 2 PRBs and Resource #2 is 4 PRBs) to an MBS-capable UE to receive the MBS #1. Firstly, the MBS-capable UE may select Resource #1 for MBS data reception. If the MBS-capable UE fails to receive the MBS #1, the MBS-capable UE may send NACK to the gNB. Then, the MBS-capable UE may directly select the Resource #2 for MBS data reception. If the MBS-capable UE still fails to decode MBS data, the MBS-capable UE may transmit NACK to the gNB. The MBS-capable UE may monitor DCI scrambled with C-RNTI in an MBS-specific search space (e.g., the search space configured to the MBS) or UE-specific search space to obtain the scheduling information of unicast transmission for MBS data reception.

The network may indicate 2 DL physical resources (e.g., Resource #1 is 2 PRBs and Resource #2 is 4 PRBs) to an MBS-capable UE to receive the MBS #1. The MBS-capable UE may select Resource #2 for MBS data reception. If the UE has failed to decode MBS data, the UE may send the request for unicast transmission to the gNB for MBS data reception. In one example, the UE may monitor DCI scrambled with an MBS-related RNTI (e.g., G-RNTI, M-RNTI) in the UE-specific search space to obtain the scheduling information for unicast transmission for MBS data reception. In one example, the UE may monitor DCI scrambled with an MBS-related RNTI (e.g., G-RNTI, M-RNTI) in the MBS-specific search space to obtain the scheduling information for unicast transmission for MBS data reception. In one example, the UE may monitor DCI scrambled with C-RNTI in the UE-specific search space to obtain the scheduling information for unicast transmission for MBS data reception. In one example, the UE may monitor DCI scrambled with a C-RNTI in the MBS-specific search space to obtain the scheduling information for unicast transmission for MBS data reception.

After a UE transmits a NACK or a request for uni cast transmission in response to (a DL TB) of an MBS, the UE may immediately begin to monitor (a set) of search space(s)/CORESET(s) for DCI(s) associated with a C-RNTI or another type of RNTI (e.g., G-RNTI, M-RNTI), which schedules a unicast transmission of this MBS.

After a UE transmits a NACK or a request for uni cast transmission in response to (a DL TB) of an MBS data reception, the UE at a period of time may monitor (a set) of search space(s)/CORESET(s) for DCI(s) associated with a C-RNTI or another type of RNTI (e.g., G-RNTI, M-RNTI), which schedules a unicast transmission of MBS. It is noted that this period of time may be preconfigured at the UE or may be configured by the network via a SIBx or dedicated signaling.

The unicast transmission may be implicitly triggered when an MBS-capable UE transmits NACK corresponding to the received MBS data.

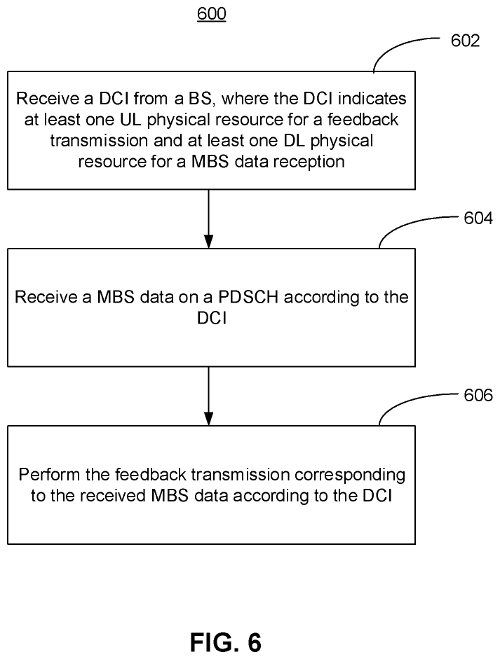

FIG. 6 is a flowchart illustrating a method 600 for a UE to perform a feedback transmission for an MBS. In action 602, the UE receives DCI from a BS, where the DCI indicates at least one UL physical resource for a feedback transmission and at least one DL physical resource for an MBS data reception. In action 604, the UE receives the MBS data on a PDSCH according to the DCI. In action 606, the UE performs the feedback transmission corresponding to the received MBS data according to the DCI.

In one example, the DCI is scrambled with an MBS-related RNTI, a common RNTI, or a UE-specific RNTI.

The DCI may indicate MCS and/or time/frequency resource associated with the PDSCH for the UE to receive the MBS data.

In one example, the UE obtains the at least one UL physical resource for the feedback transmission or the at least one DL physical resource for the MBS data reception via the DCI monitored in a common search space, a UE-specific search space, or a dedicated search space set used for the MBS.

In one example, the UL physical resource is a common UL physical resource or a dedicated UL physical resource.

In one example, the UE transmits, to the BS, feedback information including NACK or a CSI report when the UL physical resource is the common UL physical resource (e.g., an MBS-specific physical resource).

In one example, the UE transmits, to the BS, feedback information including ACK/NACK or a CSI report when the UL physical resource is the dedicated UL physical resource (e.g., UE-specific physical resource).

In one example, the UE receives, from the BS, at least one of an RRC message and a SIB indicating time and frequency information associated with the UL physical resource, and performs the feedback transmission according to the UL physical resource in the DCI and the time and frequency information in at least one of the RRC message and the SIB.

In one example, the time and frequency information associated with the UL physical resource includes at least one of a timing offset, a frequency offset, a starting time or frequency, ending time or frequency, and duration of time or frequency.

In one example, the RRC message or the SIB further indicates whether the MBS supports the feedback transmission.

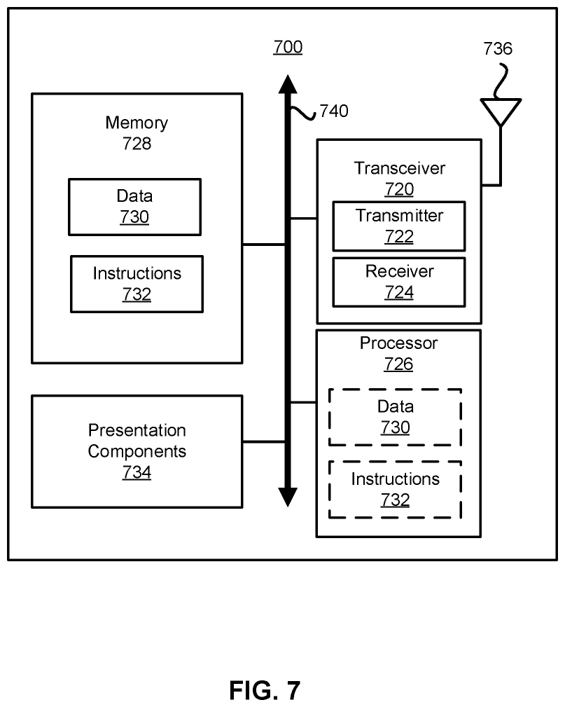

FIG. 7 is a block diagram illustrating a node 700 for wireless communication, according to an implementation of the present disclosure.

As illustrated in FIG. 7, the node 700 may include a transceiver 720, a processor 726, a memory 728, one or more presentation components 734, and at least one antenna 736. The node 700 may also include a Radio Frequency (RF) spectrum band module, a BS communications module, a network communications module, a system communications management module, input/output (I/O) ports, I/O components, and a power supply (not illustrated in FIG. 7).

Each of these components may be in communication with each other, directly or indirectly, over one or more buses 740. The node 700 may be a UE or a BS that performs various disclosed functions illustrated in FIG. 6 and examples in this disclosure.

The transceiver 720 may include a transmitter 722 (with transmitting circuitry) and a receiver 724 (with receiving circuitry) and may be configured to transmit and/or receive time and/or frequency resource partitioning information. The transceiver 720 may be configured to transmit in different types of subframes and slots including, but not limited to, usable, non-usable, and flexibly usable subframes and slot formats. The transceiver 720 may be configured to receive data and control channels.

The node 700 may include a variety of computer-readable media. Computer-readable media may be any media that can be accessed by the node 700 and include both volatile (and non-volatile) media and removable (and non-removable) media. Computer-readable media may include computer storage media and communication media. Computer storage media may include both volatile (and/or non-volatile), as well as removable (and/or non-removable), media implemented according to any method or technology for storage of information such as computer-readable media.

Computer storage media may include RAM, ROM, EPROM, EEPROM, flash memory (or other memory technology), CD-ROM, Digital Versatile Disk (DVD) (or other optical disk storage), magnetic cassettes, magnetic tape, magnetic disk storage (or other magnetic storage devices), etc. Computer storage media do not include a propagated data signal.

Communication media may typically embody computer-readable instructions, data structures, program modules, or other data in a modulated data signal, such as a carrier wave, or other transport mechanisms and include any information delivery media. The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the disclosed media should be included within the scope of computer-readable media.

The memory 728 may include computer-storage media in the form of volatile and/or non-volatile memory. The memory 728 may be removable, non-removable, or a combination thereof. For example, the memory 728 may include solid-state memory, hard drives, optical-disc drives, etc. As illustrated in FIG. 7, the memory 728 may store computer-readable and/or computer-executable instruction 732 (e.g., software codes) that are configured to, when executed, cause the processor 726 (e.g., processing circuitry) to perform various disclosed functions. Alternatively, the instruction 732 may not be directly executable by the processor 726 but may be configured to cause the node 700 (e.g., when compiled and executed) to perform various disclosed functions.

The processor 726 may include an intelligent hardware device, a central processing unit (CPU), a microcontroller, an ASIC, etc. The processor 726 may include memory. The processor 726 may process the data 730 and the instruction 732 received from the memory 728, and information received through the transceiver 720, the baseband communications module, and/or the network communications module. The processor 726 may also process information to be sent to the transceiver 720 for transmission via the antenna 736, and/or to the network communications module for transmission to a CN.

One or more presentation components 734 may present data to a person or other devices. Presentation components 734 may include a display device, a speaker, a printing component, a vibrating component, etc.

From the present disclosure, it is evident that various techniques can be utilized for implementing the disclosed concepts without departing from the scope of those concepts. Moreover, while the concepts have been disclosed with specific reference to specific implementations, a person of ordinary skill in the art would recognize that changes can be made in form and detail without departing from the scope of those concepts. As such, the present disclosure is to be considered in all respects as illustrative and not restrictive. It should also be understood that the present disclosure is not limited to the specific disclosed implementations, but that many rearrangements, modifications, and substitutions are possible without departing from the scope of the present disclosure.

1-16. (canceled)

17. A method of performing a feedback transmission for a multicast or broadcast service (MBS) for a user equipment (UE), the method comprising:
receiving, from a base station (BS), a radio resource control (RRC) message enabling the UE to provide Hybrid Automatic Repeat Request (HARQ) Acknowledgment (ACK) information for a physical downlink shared channel (PDSCH) reception corresponding to the MBS;
receiving, from the BS, a first downlink control information (DCI) format that schedules a first PDSCH for receiving MBS data, the first DCI format being a DCI format with Cyclic Redundancy Check (CRC) scrambled by a Group-Radio Network Temporary Identifier (G-RNTI);
determining a physical uplink control channel (PUCCH) resource according to the first DCI format;
transmitting, to the BS, first HARQ ACK information corresponding to the first PDSCH on the PUCCH resource; and
receiving, from the BS, a second PDSCH providing a retransmission of the MBS data, the second PDSCH being scheduled by a second DCI format using the G-RNTI or a Cell-Radio Network Temporary Identifier (C-RNTI).

18. The method of claim 17, wherein the first HARQ ACK information includes an Acknowledgment (ACK) value or a Negative-acknowledgment (NACK) value that indicates a decoding status of the MBS data.

19. The method of claim 17, wherein in a case that the second PDSCH is scheduled by the second DCI format using the C-RNTI, the second PDSCH is transmitted by the BS via a unicast transmission.

20. A user equipment (UE) for performing a feedback transmission for a multicast or broadcast service (MBS), the UE comprising:
at least one processor; and
at least one memory coupled to the at least one processor, the at least one memory storing computer-executable instructions that, when executed by the at least one processor, cause the UE to:
receive, from a base station (BS), a radio resource control (RRC) message enabling the UE to provide Hybrid Automatic Repeat Request (HARQ) Acknowledgment (ACK) information for a physical downlink shared channel (PDSCH) reception corresponding to the MBS;
receive, from the BS, a first downlink control information (DCI) format that schedules a first PDSCH for receiving MBS data, the first DCI format being a DCI format with Cyclic Redundancy Check (CRC) scrambled by a Group-Radio Network Temporary Identifier (G-RNTI);
determine a physical uplink control channel (PUCCH) resource according to the first DCI format;
transmit, to the BS, first HARQ ACK information corresponding to the first PDSCH on the PUCCH resource; and
receive, from the BS, a second PDSCH providing a retransmission of the MBS data, the second PDSCH being scheduled by a second DCI format using the G-RNTI or a Cell-Radio Network Temporary Identifier (C-RNTI).

21. The UE of claim 20, wherein the first HARQ ACK information includes an Acknowledgment (ACK) value or a Negative-acknowledgment (NACK) value that indicates a decoding status of the MBS data.

22. The UE of claim 20, wherein in a case that the second PDSCH is scheduled by the second DCI format using the C-RNTI, the second PDSCH is transmitted by the BS via a unicast transmission.

23. A base station (BS) for performing a feedback transmission for a multicast or broadcast service (MBS), the BS comprising:
at least one processor; and
at least one memory coupled to the at least one processor, the at least one memory storing computer-executable instructions that, when executed by the at least one processor, cause the BS to:
transmit, to a user equipment (UE), a radio resource control (RRC) message enabling the UE to provide Hybrid Automatic Repeat Request (HARQ) Acknowledgment (ACK) information for a physical downlink shared channel (PDSCH) reception corresponding to the MBS;
transmit, to the UE, a first downlink control information (DCI) format that schedules a first PDSCH for transmitting MBS data, the first DCI format being a DCI format with Cyclic Redundancy Check (CRC) scrambled by a Group-Radio Network Temporary Identifier (G-RNTI);
receive, from the UE, first HARQ ACK information corresponding to the first PDSCH on a physical uplink control channel (PUCCH) resource; and
transmit, to the UE, a second PDSCH providing a retransmission of the MBS data, the second PDSCH being scheduled by a second DCI format using the G-RNTI or a Cell-Radio Network Temporary Identifier (C-RNTI).

24. The BS of claim 23, wherein the first HARQ ACK information includes an Acknowledgment (ACK) value or a Negative-acknowledgment (NACK) value that indicates a decoding status of the MBS data.

25. The BS of claim 23, wherein in a case that the second PDSCH is scheduled by the second DCI format using the C-RNTI, the second PDSCH is transmitted by the BS via a unicast transmission.
